(19) United States
(12) Patent Application Publication
(10) Pub. No.: US 2019/0364083 A1
(43) Pub. Date: Nov. 28, 2019

(54) METHODS, APPARATUSES, AND COMPUTER-READABLE MEDIUM FOR REAL TIME DIGITAL SYNCHRONIZATION OF DATA

(71) Applicant: Re Mago Holding LTD, London (GB)

(72) Inventors: Marco Valerio Masi, Lugano Paradiso (CH); Cristiano Fumagalli, Segrate (IT)

(21) Appl. No.: 16/420,826

(22) Filed: May 23, 2019

Related U.S. Application Data
(60) Provisional application No. 62/676,476, filed on May 25, 2018.

(51) Int. Cl. H04L 29/06

(52) U.S. Cl. CPC H04L 65/605; H04L 65/4015; H04L 65/1089

(57) ABSTRACT

Methods, apparatuses, and computer-readable medium are disclosed for real time synchronization of data between a presenter and multiple devices being operated by remote third party users. The specialized processors disclosed herein are directed to receiving additional information generated by third party remote users and transmitting the same information with other party users and with the original presenter by having the additional information transmitted to a flat screen via a projector.

### RELATED APPLICATION DATA

This application claims priority to U.S. Provisional Application No. 62/676,476, filed May 25, 2018, the disclosure of which is hereby incorporated by reference in its entirety.

### BACKGROUND

A presenter presenting materials to an audience often uses a board or a flat surface to display his or her materials to the audience. The flat surface is the means by which the presenter presents his or her materials and ideas to the audience. Traditionally, these boards are often set up, for example, in a classroom, office, a conference hall, or a stadium, which is easily accessible to the presenter and viewable by the audience.

One skilled in the art would appreciate that a board or a flat surface is often the means for communicating one's ideas or concepts to his or her audience members. For example, in a classroom or in an office space, the presenter uses a marker to sketch out his or her concepts on the board. Thereby, conveying his or her concepts to the audience members. Alternatively and commonly used in the present modern day technology, the presenter may create a power point presentation to share his or her concepts with the audience members. The power point presentation is often projected on a flat surface using a projector and a computer or a laptop.

However, conventional boards or flat surfaces are not digitally synchronized with the audience member's personal devices such as notepads, computers, laptops, iPads, smartphones, etc. This often creates a problem for members when they are trying to acquire or obtain the information for later use. The audience members often have to resort to copious note taking, or alternatively, recording the presentation and capturing images of the board using their personal handheld devices such as cameras, smart phones or iPads. This often results in bad quality images that do not represent all the concepts covered by the presentation. Moreover, the images of the presentation are spread over multiple devices of different audience members, which are not synced to other audience member's devices. This often creates a challenge for the audience members to fully obtain the information from the board for later use. Moreover, with the lack of digital synchronization between the flat surface and the audience members' personal devices, the audience members' are unable to share their ideas, viewpoints and concepts with the other audience members.

Conventional implementations directed to presenting materials and ideas on a flat surface often do not promote sharing of the materials presented to various audience members and acquiring their input in real time that would encourage collaboration of various viewpoints. Thus, there is a need for technological improvements that processes information from various users, such as an original presenter and third party users (i.e., audience members), filters the received information to retrieve the additional information provided by the third party users, and projects the additional information back onto the flat surface such that collaborative viewpoints of all the participating third party users is achieved.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 illustrates a side view of a system for projecting data on a flat surface.

FIG. 2 illustrates a front view of the system for projecting data on the flat surface as shown in FIG. 1.

FIG. 3 illustrates a sleeve device according to an exemplary embodiment.

FIG. 4 illustrates the architecture of the sleeve device represented in FIG. 3 according to an exemplary embodiment.

FIG. 5 illustrates the use of the sleeve device on the flat surface.

FIG. 6 illustrates the architecture of the system involving multiple devices according to an exemplary embodiment.

FIG. 7 illustrates the communication flow diagram of data between multiple devices according to an exemplary embodiment.

FIG. 8 illustrates the architecture of the specialized computer used in the system shown in FIG. 1 according to an exemplary embodiment.

FIG. 9 illustrates the projector used in the system shown in FIG. 1 according to an exemplary embodiment.

FIG. 10 illustrates a convex optical system used in a projector.

FIG. 11 illustrates a concave optical system used in a projector.

FIG. 12 illustrates an optical system with a concave mirror having a free-form surface used in the projector shown in FIG. 1.

FIG. 13 illustrates a cross-section of the projector used in the system shown in FIG. 1 as data is projected onto the flat screen.

FIG. 14 illustrates a side view of the system as data is projected onto the flat surface.

FIG. 15 illustrates a specialized algorithm for performing boundary correction according to an exemplary embodiment.

FIGS. 16-17 illustrate a specialized algorithm that is representative of the computer software receiving plurality of XYZ coordinates from the sleeve device shown in FIG. 1 according to an exemplary embodiment.

FIG. 18 illustrates a specialized algorithm that is representative of the computer software receiving data generated by the multiple third party users according to an exemplary embodiment.

FIG. 19 illustrates a specialized algorithm that is representative of the computer software updating its memory with the XYZ coordinates from the sleeve devices shown in FIG. 1 according to an exemplary embodiment.

FIGS. 20-21 illustrates a specialized algorithm representative of the computer software receiving data from the original presenter and the multiple third party users, updating the memory with the additional information, and filtering the data generated from the original presenter from the data generated by the multiple third party users according to an exemplary embodiment.

FIGS. 22-23 illustrates a specialized algorithm that is representative of the computer software receiving data from the original presenter that corresponds to erasing or removing of information according to an exemplary embodiment.

FIGS. 24A-B illustrates a specialized algorithm for synchronizing data in real time across analog and digital workspaces according to an exemplary embodiment.

### DETAILED DESCRIPTION

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the novel systems and methods disclosed herein, whether implemented independently of, or combined with, any other aspect of the disclosure. For example, a system can be implemented or a method can be practiced using any number of aspects set forth herein. In addition, the scope of the disclosure is intended to cover such a system or method that is practiced using other structure, functionality, or structure and functionality in addition to or other than the various aspects of the disclosure set forth herein. It should be understood that any aspect disclosed herein can be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

Detailed descriptions of the various implementations and variants of the system and methods of the disclosure are now provided. While many examples discussed herein are in the context of synchronization of data between multiple devices that is generated by various users, it will be appreciated one skilled in the art that the described systems and methods contained herein can be used in related technologies pertaining to synchronization of data. Myriad other example implementations or uses for the technology described herein would be readily envisioned by those having ordinary skill in the art, given the contents of the present disclosure.

The foregoing needs are satisfied by the present disclosure, which provides for, inter alia, methods, apparatuses, and computer readable medium for synchronizing data between multiple devices. Example implementations described herein have innovative features, no single one of which is indispensable or solely responsible for their desirable attributes. Without limiting the scope of the claims, some of the advantageous features will now be summarized.

Applicants have discovered methods, systems and non-transitory computer readable mediums that can synchronize data between different devices generated by different users. In particular, solution to digitally synchronizing flat surfaces or boards with various devices is by using a specialized software or algorithm that recognizes data from different user devices and presents them on the flat surface in a collaborative fashion. The inventive concepts generally include an infrared or ultrasound sensor incorporated in a sleeve device that is used for generating data on the flat surface. The position of the sleeve device is received by the specialized processor that transmits or streams that data to various third party users. Thereby, the specialized processor syncs the various devices with the information being presented on the flat screen. Further, the specialized processor transmits data back to the flat surface based on the information it receives from the third party users via their respective devices. The various algorithms performed by the specialized processors are described in further detail below.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

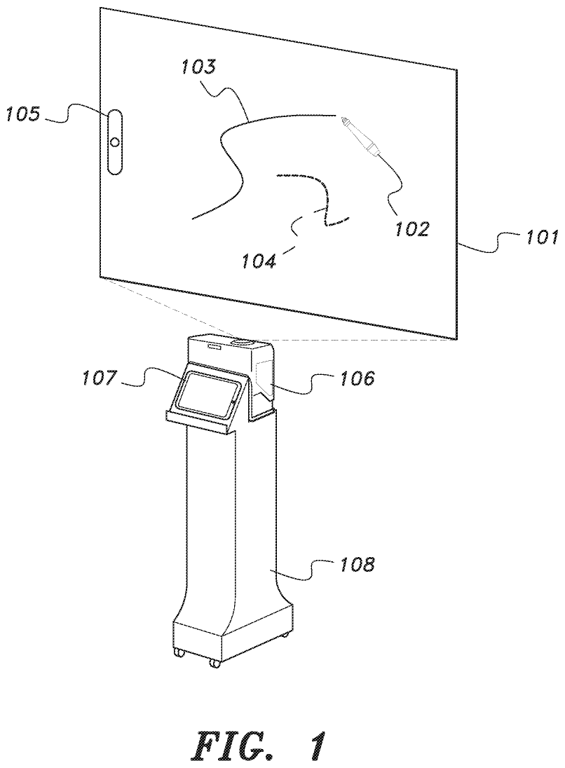

Now referring to FIG. 1, a side view of the system for projecting data on a flat surface is represented. The system includes a flat surface 101, a sleeve device 102, a slider 105, a projector 106, a stand 108, and a specialized computer 107. As shown in FIG. 1, the projector 106 is configured to project an image on the flat surface 101. The flat surface 101 shown in FIG. 1 represents data generated by a presenter 103 and data generated by a third party remote user 104. As discussed in further detail below, the specialized computer 107 is configured to receive data generated by a third party remote user 104 and have the same displayed on the flat surface 101 by transmitting a signal to the projector 106. Thereby, allowing a collaborative effort and sharing of various ideas and viewpoints between the presenter and the third party remote users.

The flat surface 101 as shown in FIG. 1 may correspond to, including but not limited to, a white board made of either melamine, porcelain or glass, a dry erase board, a screen, or a fiberboard. With respect to the third party remote users, they may correspond to either an individual or a group of people that are physically located in the same room where the presenter is presenting his or her materials. Or, alternatively, they may refer to individuals or group of people that are connected to the presentation through an internet connection, via their personal devices such as notepads, iPads, smartphones, tablets, etc., and are viewing the presentation online from a remote location such as their home or office.

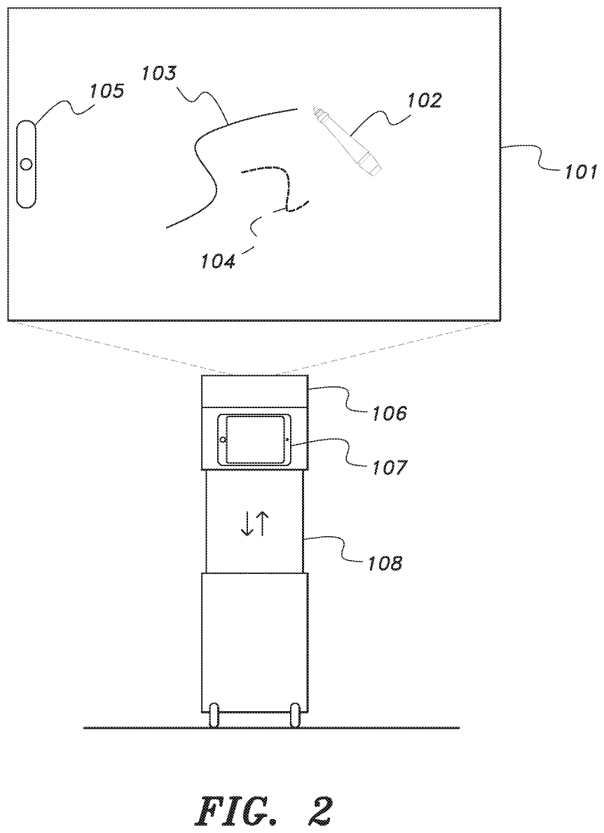

FIG. 2 represents a front view of the system including all of the same components as described with respect to FIG. 1. FIG. 2 further illustrates the stand 108 to have an adjustable height as shown by the arrows. The stand 108 can have its height adjusted in a telescopic fashion such that it may go from a first height to a different second height as desired by a user. For example, the stand 108 may have its height adjusted between 60 centimeters to 85 centimeters.

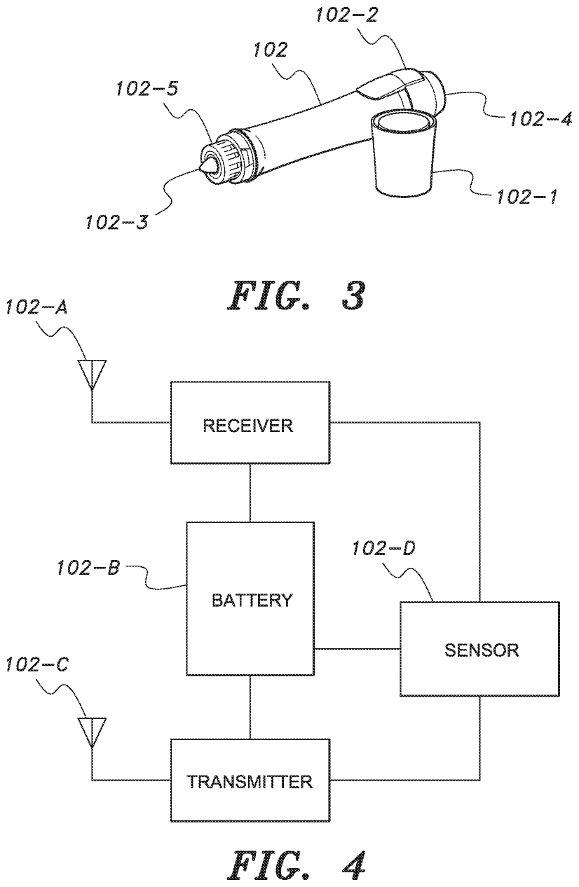

Next, FIG. 3 illustrates a sleeve device 102 that is used in the system shown in FIG. 1 according to an exemplary embodiment. The sleeve device 102 represents the Re Mago Tools hardware and Re Mago Magic Pointer Suite software solutions. The sleeve device 102 includes a cap 102-1, a proximal end 102-4 and a distal end 102-5. The cap 102-1 is configured to be placed on the distal end 102-5. Further, the sleeve device 102 includes an infrared or ultrasound sensor (not shown) incorporated within the sleeve device 102, an actuator 102-2 and an inner sleeve (not shown) that is configured to receive at least one marker 102-3 therein. The infrared or ultrasound sensor is configured to capture the XYZ (i.e., x-axis (horizontal position); y-axis (vertical position); and z-axis (depth position)) coordinates of the tip of the marker as the sleeve device 102 (including the marker therein) is used to draw sketches, flipcharts, graphs, etc., and/or generate data, on the flat surface 101. The sensor is capable of capturing the XYZ coordinates of the tip of the marker 102-3 upon actuation of the actuator 102-2. That is, once the user or presenter is ready to start with his or her presentation and wants to share the contents generated on the flat surface 101 with the remote third party users, the presenter will press down on the actuator 102-2 that would indicate to the sensor to start collecting the XYZ coordinates of the tip of the marker 102-3, and transmitting the same to the specialized computer 107. The infrared or ultrasound sensor continuously transmits the location coordinates of the tip of the marker 102-3 as long as the actuator 102-2 is in the actuated position.

FIG. 4, described in conjunction with FIG. 3, illustrates the architecture of the sleeve device 102 according to an exemplary embodiment. As shown in FIG. 4, the sleeve device 102 includes a receiver 102-A, a battery 102-B, a transmitter 102-C and a sensor 102-D. The sensor 102-D, which is the infrared or ultrasound sensor, starts collecting or capturing the XYZ coordinates of the tip of the marker 102-3 after the receiver 102-A receives a signal from the actuator 102-2 upon the actuator 102-2 is pressed down by the user. The actuating of the actuator 102-2 by pressing down on the same indicates to the receiver 102-A to start collecting or capturing the XYZ coordinates of the tip of the marker 102-3. The receiver 102-A relays these coordinates to the transmitter 102-C. In real time, the transmitter 102-C starts transmitting these coordinates to the specialized computer 107. The receiver 102-A, the sensor 102-D and the transmitter 102-C are operated by battery 102-B.

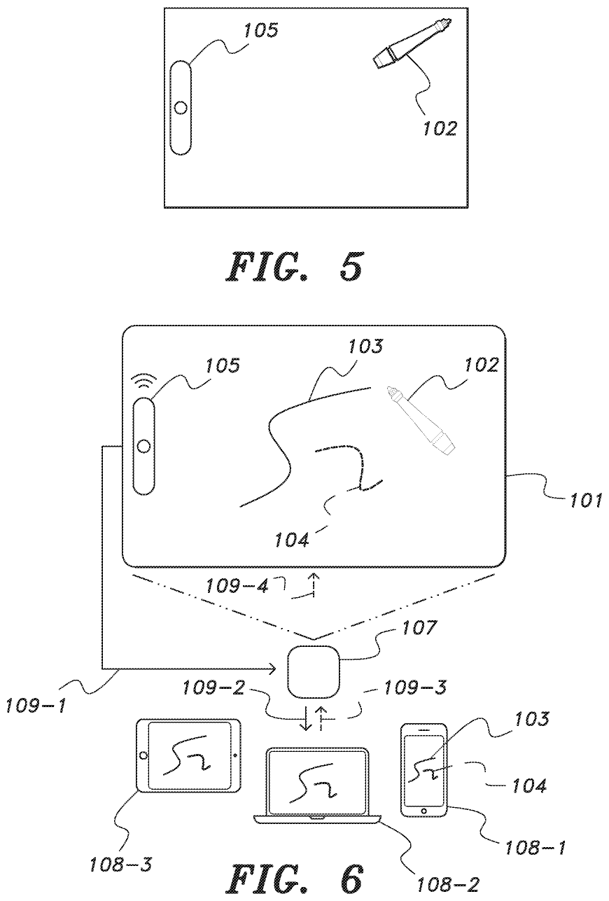

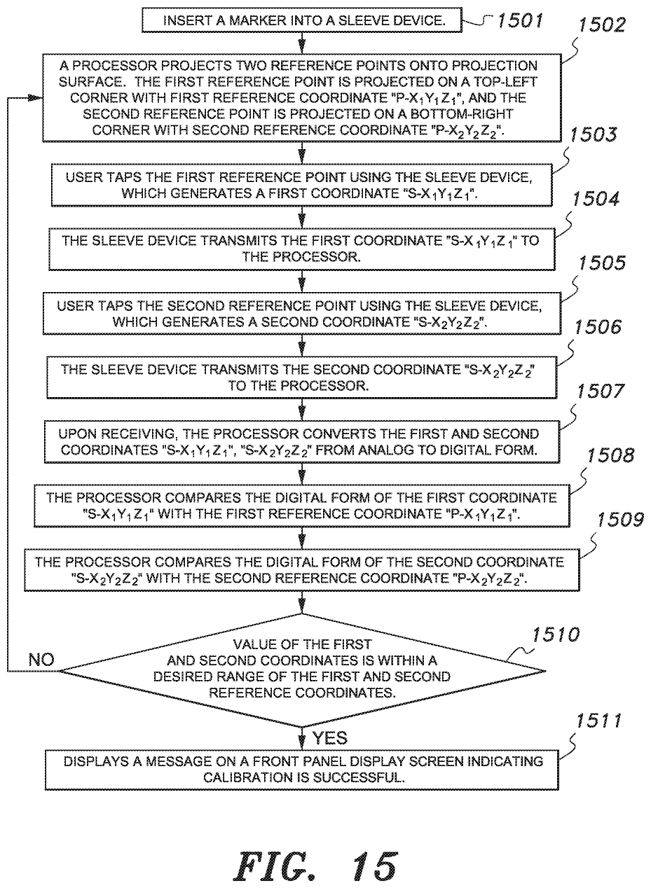

Next, referring to FIG. 5, illustrates the working of the sleeve device 102 on the flat surface 101. In particular, the sleeve device 102 is shown contacting a top right corner of the flat surface 101 for calibration purposes. The calibration process is the preliminary step that the presenter performs prior to starting his or her presentation. The calibration step is discussed in more detail below with respect to FIG. 15.

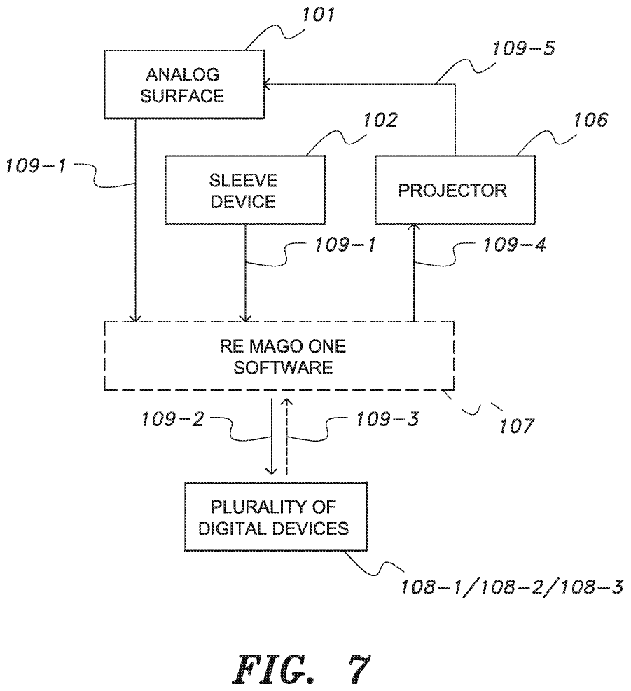

Next, referring to FIGS. 6 and 7, an overall architecture and the communication flow diagram between multiple devices is represented. FIG. 6 illustrates the architecture of the system illustrated in FIG. 1, wherein the flat surface 101, the sleeve device 102, the specialized computer 107 and the plurality of devices 108-1, 108-2, and 108-3 operated by remote third party users are depicted. The communication flow diagram shown in FIG. 7 represents communication between these aforementioned devices. These aforementioned devices may communicate wirelessly or via a wired transmission. As illustrated in FIGS. 6 and 7, the flat surface 101 and the sleeve device 102 are configured to transmit signals 109-1 to the specialized computer 107. These signals 109-1 correspond to the XYZ coordinates transmitted by the sleeve device 102 and the thickness and angle rotation transmitted by the flat surface 101. The specialized computer 107 is configured to forward the information or data 103 received from the flat surface 101 and the sleeve device 102 to the plurality of remote devices 108-1, 108-2, 108-3 as shown by transmission signal 109-2.

Further, as illustrated in FIG. 6, the specialized computer 107 is configured to receive additional information 104 from the plurality of remote devices 108-1, 108-2, 108-3 as represented by transmission signal 109-3. The plurality of remote devices 108-1, 108-2, 108-3 have Re Mago Magic Pointer Suite software or Re Mago Workspace application software installed therein. The additional information 104 received by the specialized computer 107 from the plurality of remote devices 108-1, 108-2, 108-3 is different from the information or data 103 received by the specialized computer 107 from the sleeve device 102. The specialized computer 107 is configured to transmit the additional information 104 received from the plurality of remote devices 108-1, 108-2, 108-3 to the flat surface 101 via the projector 106. The additional information 104 is representative of the additional information provided by the third party remote users via the plurality of remote devices 108-1, 108-2, 108-3.

As shown in FIG. 6, the information 103 transmitted from the specialized computer 107 to the plurality of remote devices 108-1, 108-2, 108-3 is displayed on the screen of these devices. For example, the remote devices 108-1, 108-2, 108-3 that have the Re Mago Magic Pointer Suite software or Re Mago Workspace application software installed therein are able to view a virtual representation of the flat surface 101 on their screen. This allows the remote third party users to view the presentation on their personal devices in real time. The remote third party users use their respective devices to add the additional information 104, which in turn, is transmitted 109-3 to the specialized computer 107. Each remote third party user is able to contribute his or her ideas to the presenter and with other third party users. Thereby, promoting a collaborative effort in discussing the topic of discussion between the presenter and the remote third party users.

As illustrated in FIG. 7, the signal transmissions between the various devices are shown as the signals are converted from analog signals to digital signals and vice-versa. For example, signals 109-1 received from the flat surface 101 and the sleeve device 102 are received by the specialized computer 107 in analog form. The specialized processor 107 converts the analog signals 109-1 to a digital signals 109-2 and transmits the same to the plurality of remote devices 108-1, 108-2, 108-3. The specialized processor 107 may alternatively transmit the digital signals 109-2 to a server (not shown), which streams the information 103 to the plurality of remote devices 108-1, 108-2, 108-3. That is, the specialized computer 107 may transmit the digital signals 109-2 either directly to the remote devices 108-1, 108-2, 108-3, or alternatively via a server.

The third party remote users upon receiving the digital signals 109-2 on their remote devices 108-1, 108-2, 108-3, may add additional information or data 104 on their respective devices. The additional information or data 104 is different from the original data or information 103 provided by the presenter. After adding the additional information or data 104, the remote third party users may share the same with other remote third party users and with the presenter itself. In order to do so, the respective device may transmit signals 109-3 either directly to the specialized computer 107 or to a server. If the additional information 104 is directly received by the specialized computer 107, the specialized computer 107 may transmit that information to a server in order for that information to be disseminated between other remote third party users.

The specialized processor 107 may directly receive the signals 109-3 in digital form from the plurality of remote devices 108-1, 108-2, 108-3, which includes the additional information 104 entered by the remote third party users. The specialized processor 107 receives the digital signals 109-3, and transmits the same to the projector 106. The projector 106 converts the signals 109-3 to analog signals 109-5, which corresponds to the additional information 104. This additional information 104 is broadcasted to the flat surface 101 by the projector 106.

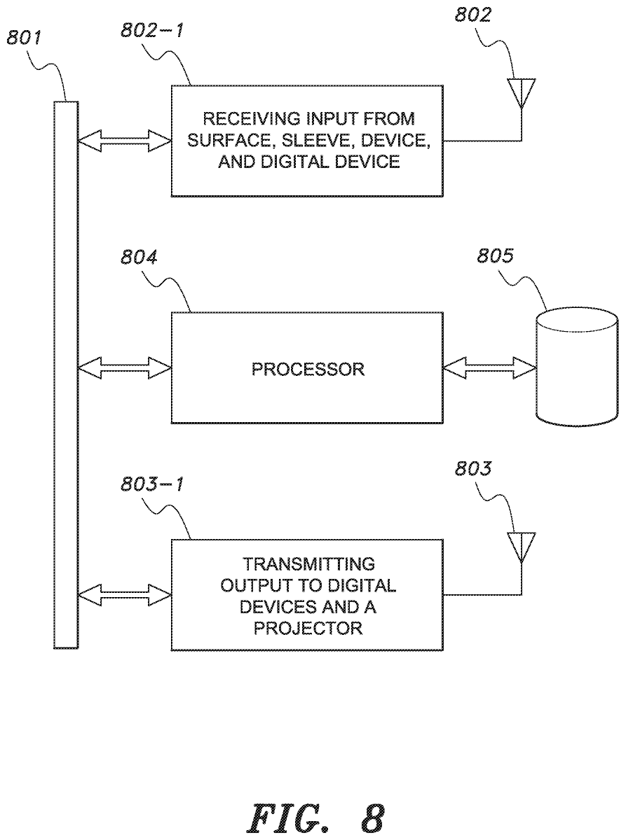

Next referring to FIG. 8, the architecture of the specialized computer 107 used in the system shown in FIG. 1 is illustrated according to an exemplary embodiment. As represented in FIG. 8, the specialized computer includes a data bus 801, a receiver 802, a transmitter 803, at least one processor 804, and a memory 805. The receiver 802, the processor 804 and the transmitter 803 all communicate with each other via the data bus 801. The processor 804 is a specialized processor configured to execute specialized algorithms. The processor 804 is configured to access the memory 805 which stores computer code or instructions in order for the processor 804 to execute the specialized algorithms. The algorithms executed by the processor 804 are discussed in further detail below. The receiver 802 as shown in FIG. 8 is configured to receive input signals 109-1, 109-3 from the flat surface 101, the sleeve device 102 and the plurality of remote devices 108-1, 108-2, 108-3. That is, as shown in 802-1, the receiver 802 receives the signals 109-1 from the flat surface 101 and the sleeve device 102; and receives the signals 109-3 from the plurality of remote devices 108-1, 108-2, 108-3. The receiver 802 communicates these received signals to the processor 804 via the data bus 801. As one skilled in the art would appreciate, the data bus 801 is the means of communication between the different components-receiver, processor, and transmitter—in the specialized computer 107. The processor 804 thereafter transmits signals 109-2 and 109-4 to the plurality of remote devices 108-1, 108-2, 108-3 and the projector 106, respectively. The processor 804 executes the algorithms, as discussed below, by accessing computer code or software instructions from the memory 805. Further detailed description as to the processor 804 executing the specialized algorithms in receiving, processing and transmitting of these signals is discussed below. The memory 805 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices.

One skilled in the art would appreciate that the server (not shown) may include architecture similar to that illustrated in FIG. 8 with respect to the specialized computer 107. That is, the server may also include a data bus, a receiver, a transmitter, a processor, and a memory that stores specialized computer readable instructions thereon. In effect, server may in turn function and perform in the same way and fashion as the specialized computer 107 shown in FIG. 7, for example.

With respect to the projector 106 used in the system, shown in FIG. 1, there has been a significant development in this technological area. Generally, conventional portable projectors are inconvenient and provide great discomfort in use as they get hot and noisy over a period of time, and often project images on the presenter himself during the presentation. Having a projector installed on the ceiling solves these problems, but such projectors are often expensive. Ultra-short-throw projectors were also introduced that were less expensive and had short projection distance; however, they had their own drawbacks such as being large, heavy and unsuitable for portable use. Additionally, it required cables between the projector and computer or laptop that often provided hindrance for the presenter.

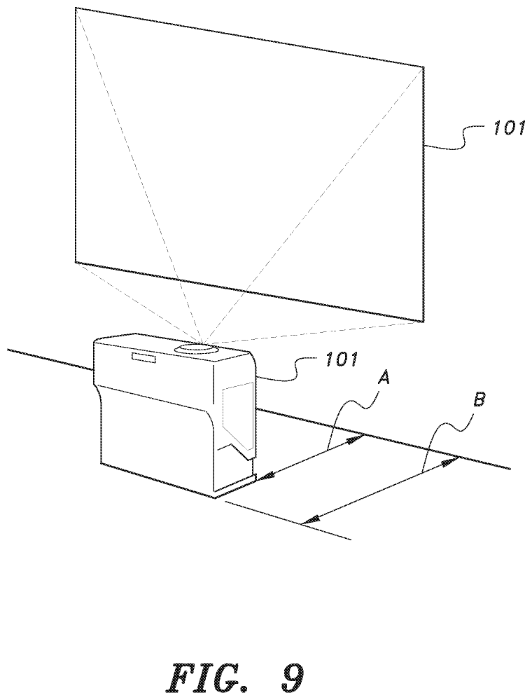

In order to overcome the aforementioned shortcomings of conventional projectors, a unique and novel projector is illustrated in FIG. 9. Next referring to FIG. 9, the projector 106 used in the system shown in FIG. 1 is illustrated according to an exemplary embodiment. The ultra-short-throw project shown in FIG. 9, which is developed and manufactured by Ricoh®, has solved many of the aforementioned problems faced by conventional projectors. As seen in FIG. 9, the projector 106 can be placed as close as “A” 11.7 centimeters (cm) (4.6 inches (in)) or “B” 26.1 cm (10.3 in) from the flat surface 101. The image projected by the projector 106 can be around 48 inches (in). The projector 106 is much smaller and lighter than any conventional ultra-short-throw projector.

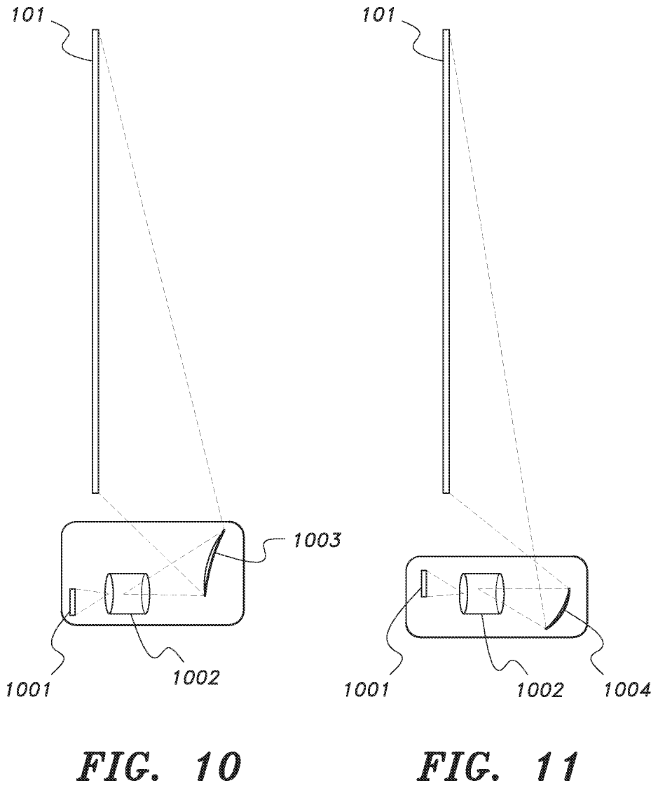

FIGS. 10-13 illustrate the inner workings of the projector 106. For example FIG. 10 illustrates a convex optical system inside of a projector that includes a display panel 1001, lenses 1002 and a convex mirror 1003. As shown in FIG. 10, the beams from the display panel 1001 reflect off the lenses 1002 and the convex mirror 1003 spreads the projection beams such that there is no space for inflection. The convex mirror 1003 is placed in the middle of beam paths, so it has to be large enough to receive the spreading beams and accordingly project a larger image on the flat surface 101. Similarly, in FIG. 11, a concave optical system is illustrated that includes a display panel 1001, lenses 1002, and a concave mirror 1004. Unlike the convex optical system, the concave optical system uses a concave mirror that has reduced the size of the optical system. With a concave mirror, an intermediate image is formed to suppress the spread of luminous flux from the lenses. The intermediate image is then enlarged and projected at one stretch with the reflective and refractive power of the concave mirror. This technology enables a large image to be projected at an ultra-close distance. The concave mirror enabled an ultra-wide viewing angle while keeping the optical system small.

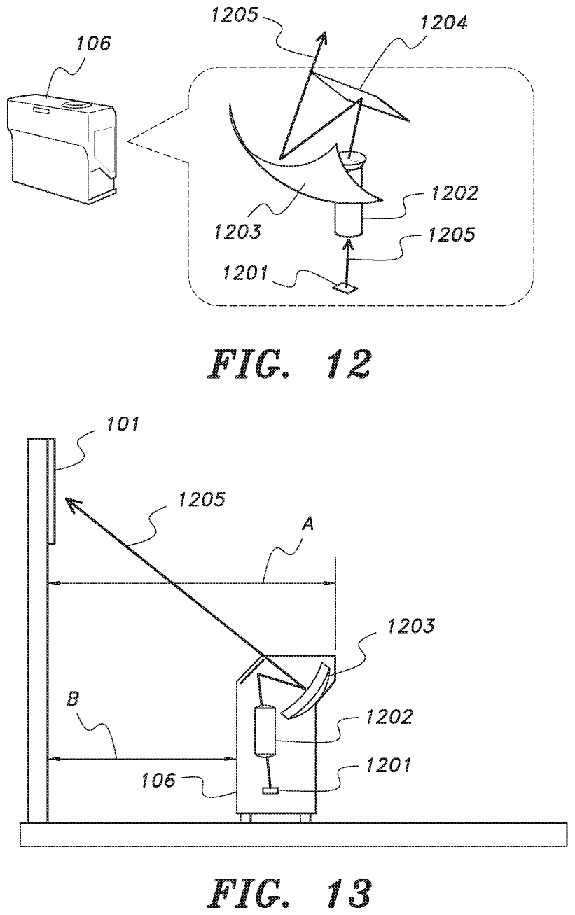

With respect to the concave optical system and convex optical system shown in FIGS. 10 and 11, use of ultra-wide viewing angles have their own challenges. Some of these challenges include increasing image distortion and lowering resolution. In order to overcome these issues, FIG. 12 represents an improved projector technology that includes a concave mirror with a free-form mirror 1203. The newly developed free-form mirror 1203 greatly increased the degree of freedom of design, which enabled smaller size for the projector and high optical performance. As shown in FIGS. 12-13, the projector 106 includes an inflected optical system 1204, lenses 1202, free-form mirror 1203, and display panel (digital image) 1201. The reflective mirror 1204 is placed between the lenses 1202 and the free-form mirror 1203. By folding the beam path in the optical system, the volume of the projector body is significantly reduced. This design allows the projector 106 to be brought closer to the flat surface 101 while enabling a large image (a 48-inch image in the closest range). For example, as shown in FIG. 13, the projector 106 can be placed about “A” 26.1 centimeters (as opposed to 39.3 centimeters) to “B” 11.7 centimeters (as opposed to 24.9 centimeters) from the flat surface 101. With the very small footprint, the new projector allows the effective use of space.

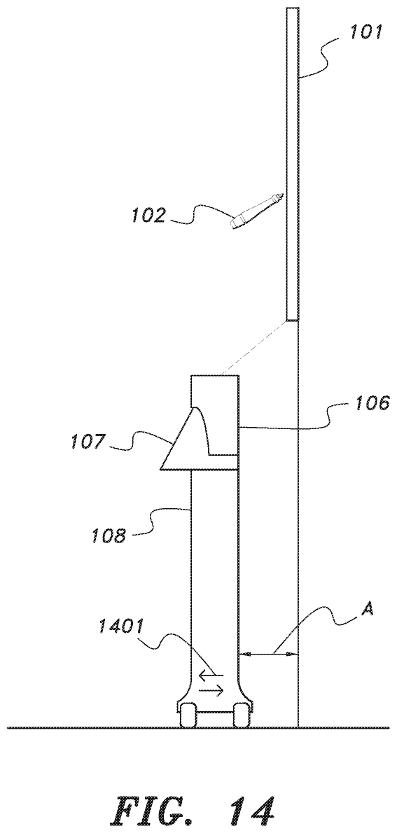

Next referring to FIG. 14, a side view of the projector 106, the stand 108 and the specialized computer 107 are shown from the flat surface 101. For example, the projector 106 may be about “A” 11.7 centimeters away from the flat surface 101 while projecting an image of about 48 inches on the flat surface 101. As shown by the arrows 1401 in FIG. 14, the stand 108 can be maneuvered a distance from the flat surface 101 thereby increasing or decreasing the distance between the projector 106 and the flat surface 101.

Next referring to FIGS. 15-24, they are directed to specialized algorithms executed by the processor 804 in the specialized computer 107. FIG. 15 represents a specialized algorithm for boundary calibration that the presenter performs prior to starting his or her presentation. As shown in FIG. 15, the following steps are performed by the presenter and the processor 804 in order to calibrate the boundary regions of the flat surface 101. At step 1501, the presenter inserts a marker into a sleeve device 102. At step 1502, the specialized processor 804 projects two reference points onto the flat surface 101. The first reference point is projected on a top-left corner of the flat surface 101 with first reference coordinate being “P-X₁Y₁Z₁”, and the second reference point is projected on a bottom-right corner of the flat surface 101 with a second reference coordinate being “P-X₂Y₂Z₂.” The processor 804 projects these two reference points upon being turned on by a user or a presenter. At step 1503, the presenter taps the first reference point using the sleeve device 102, which generates a first coordinate “S-X₁Y₁Z₁.” At step 1504, the sleeve device 102 transmits the first coordinate “S-X₁Y₁Z₁” to the processor 804. As discussed above with respect to FIGS. 3 and 4, the presenter may press down on the actuator 102-2 on the sleeve device 102, which in turn indicates to the transmitter 102-C to start transmitting coordinates to the processor 804.

At step 1505, the presenter taps the second reference point using the sleeve device 102, which generates a second coordinate “S-X₂Y₂Z₂.” One skilled in the art would appreciate that Z₁ and Z₂ may be of different value if the projector 106 is placed at an angle with respect to the flat surface 101, thereby affecting the distance between the flat surface 101 and the projector 106. At step 1506, the sleeve device 102 transmits the second coordinate “S-X₂Y₂Z₂” to the processor 804. At step 1507, upon receiving these coordinates, the processor 804 convers the first and second coordinates “S-X₁Y₁Z₁” and “S-X₂Y₂Z₂” from analog to digital form. That is, as discussed above with respect to FIG. 7, the processor 804 converts the analog signals 109-1 received from the flat surface 101 and the sleeve device 102, to digital signals 109-2 which is later transmitted to multiple devices 108-1, 108-2, 108-3 as signals 109-2. At step 1508, the processor 804 compares the digital form of the first coordinate “S-X₁Y₁Z₁” with the first reference coordinate “P-X₁Y₁Z₁”. At step 1509, the processor 804 compares the digital form of the second coordinate “S-X₂Y₂Z₂” with the second reference coordinate “P-X₂Y₂Z₂”. At step 1510, the processor 804 determines whether the value of the first and second coordinates (“S-X₁Y₁Z₁” and “S-X₂Y₂Z₂”) are within a desired range of the first and second reference coordinates (“P-X₁Y₁Z₁” and “P-X₂Y₂Z₂”). A desired range may be for example less than 1% or 2% of difference between the coordinates. If the coordinates are within a desired range, then at step 1511 the processor 804 displays a message on a front panel display screen of the specialized computer 107 indicating calibration is successful. However, if the coordinates are not within a desired range, the calibration process starts again at step 1502.

In addition to boundary calibration, the processor 804 is also capable of performing thickness and angle rotation calibration of the data created by the presenter on the flat surface 101. In particular, upon receiving a plurality of coordinates from the sleeve device 102 that are representative of the stroke or data (i.e. analog stroke) generated by the presenter on the flat surface 101, the processor 804 may locally generate a digital stroke or data in the memory 805, shown in FIG. 8, that is representative of the analog stroke. The presenter may alter the thickness and angle rotation of the digital stroke generated in the memory 805 by manipulating the slider 105. For example, manipulating the slider 105 in an upward direction may increase the thickness and angle rotation of the digital stroke, and manipulating the slider in a downward direction may decrease the thickness and angle rotation of the digital stroke. Such information is transmitted to the specialized computer 107 via signals 109-1. The specialized computer 107, upon receiving such signals 109-1, calibrates the thickness and angle rotation in its memory 805.

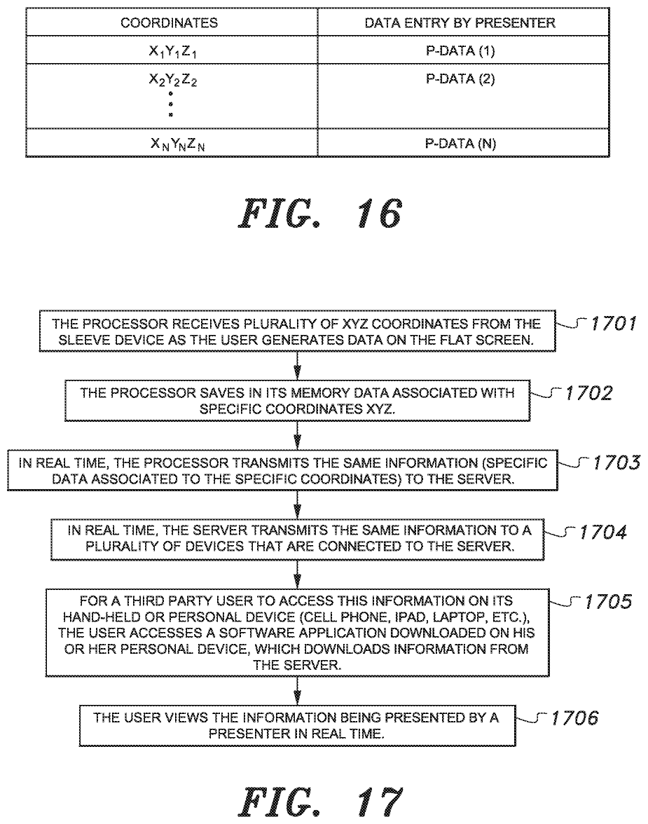

Next, referring to FIGS. 16-17 an example of a specialized algorithm for sharing presenter's data generated on the flat surface 101 with multiple third party users is shown according to an exemplary embodiment. In FIG. 17, at step 1701 the processor 804 receives plurality of XYZ coordinates from the sleeve device 102 as the presenter generates data on the flat surface 101. At step 1702, the processor 804 saves in its memory 805 data associated with the specific coordinates XYZ. For example, FIG. 16 illustrates a non-limiting example embodiment of saving data in the memory 805 in a table format. Each coordinate received by the sleeve device 102 is associated with a particular data entry by the presenter (i.e., P-Data(1), P-Data(2), etc.). At step 1703, in real time, the processor 804 transmits, via the transmitter 803 shown in FIG. 8, this information (i.e., specific data associated to specific coordinates) to a server (not shown). At step 1704, in real time, the server transmits the same information to a plurality of devices 108-1, 108-2, 108-3 that are connected to the server. At step 1705, for a remote third party user to access this information on its hand-held or personal device (i.e., cell phone, iPad, laptop, etc.) the user accesses a software application, for example Re Mago Magic Pointer Suite software solutions, downloaded on his or her personal device, which downloads information from the server. At step 1706, the remote third party users access the information presented by the presenter on their devices in real time. One skilled in the art would appreciate that steps 1703 and 1704 are non-limiting steps as the processor 804 may transmit the information directly to the plurality of devices 108-1, 108-2, 108-3, without first sending the same to the server.

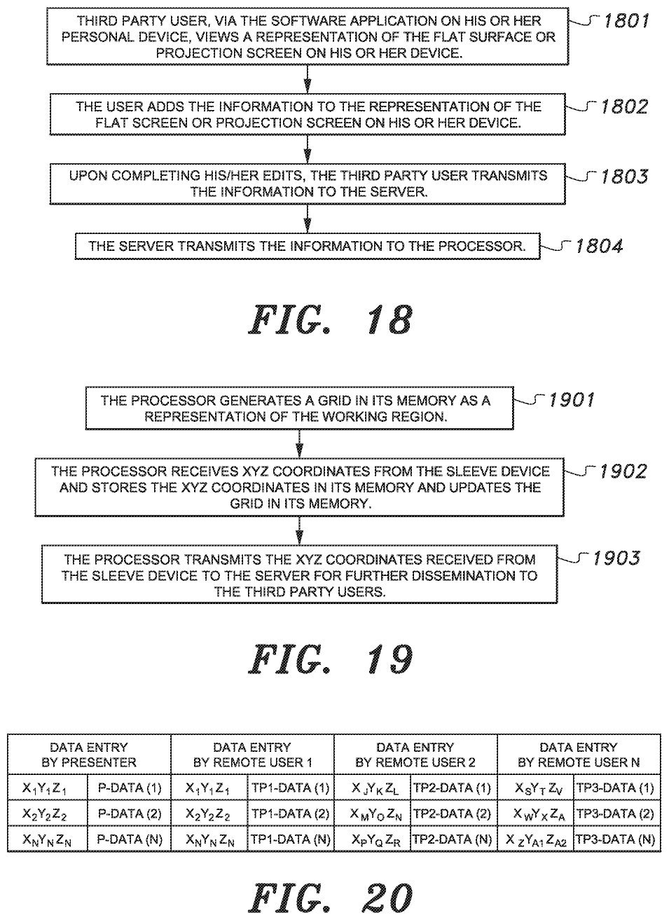

Next, referring to FIG. 18 an example of a specialized algorithm for sharing data generated by the remote third party users via their plurality of devices 108-1, 108-2, 108-3 is shown according to an exemplary embodiment. At step 1801, the remote third party user, via the software application on his or her personal device 108-1, 108-2, 108-3, views a representation of the flat surface 101 or projection screen on his or her device 108-1, 108-2, 108-3. That is, the Re Mago Magic Pointer Suite software solutions downloaded on third party users' personal devise depicts a virtual representation of the flat surface 101. At step 1802, the remote third party user adds additional information 104 to the representation of the flat screen 101 on his or her device 108-1, 108-2, 108-3. The additional information 104 constitutes information that the remote third party user contributes. At step 1803, upon completing his/her edits or adding the additional information the remote third party user transmits the information to the server from his or her device 108-1, 108-2, 108-3. And, thereafter, at step 1804, the server transmits this additional information to the processor 804. One skilled in the art would appreciate that step 1803 may alternatively constitute the additional information 104 being directly sent to the processor 804.

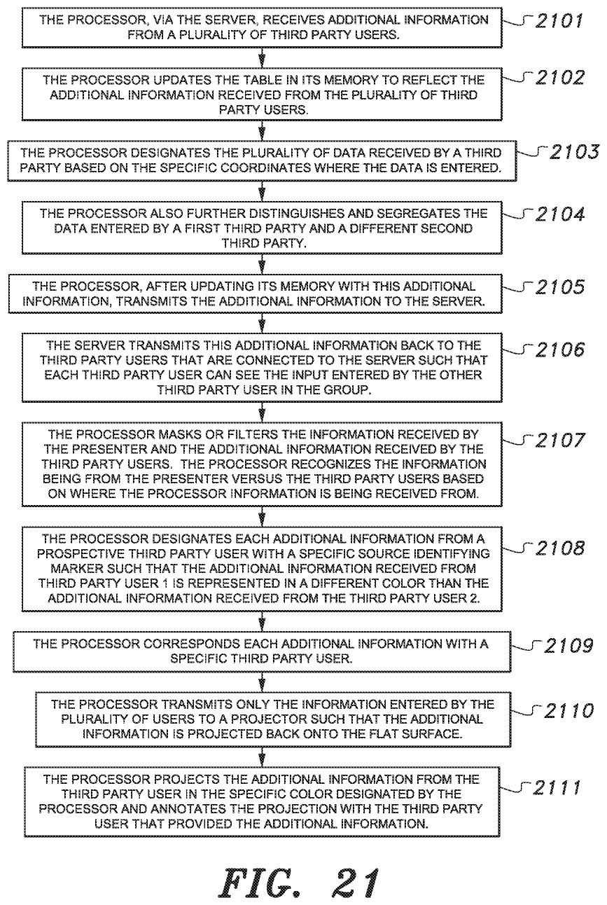

Next, FIGS. 19-23 will be discussed which are directed towards execution of the specialized algorithms by the processor 804. FIG. 19 represents a specialized algorithm executed by the processor 804 when it receives information from the presenter. At step 1901, the processor 804 generates a grid in its memory 805 as a representation of the working region on the flat surface 101. At step 1902, as the processor 804 receives the XYZ coordinates from the sleeve device 102, it stores the XYZ coordinates in its memory 805 and updates the grid in its memory 805. And, at step 1903, the processor 804 transmits, via the transmitter 803 shown in FIG. 8, the XYZ coordinates received from the sleeve device 102 and the flat surface 101 to the server for further dissemination to the plurality of devices 108-1, 108-2, 108-3 operated by the remote third party users, or alternatively directly to the plurality of devices 108-1, 108-2, 108-3.

Next, referring to FIGS. 20-21 a specialized algorithm directed to the processor 804 receiving information from the third party users and filtering the same information from the information received from the presenter is described. At step 2101, the processor 804, via the server, receives additional information from the plurality of devices 108-1, 108-2, 108-3 operated by the remote third party users. At step 2102, the processor 804 updates the table shown in FIG. 16, stored in its memory 805, to reflect the additional information received from the plurality of third devices 108-1, 108-2, 108-3. For example, the table is updated or extrapolated to include additional information provided by different third party users as shown in FIG. 20. That is, for each data point entered by a respective third party user, a unique coordinate is assigned to it as entered by the user. As shown in FIG. 20, data entered by a first third party user at coordinate XₐY_{b}Z_{c} is designated as TP1-Data(1); and the n-th data (i.e., TP3-Data(n)) entered by the n-th third party user is designated the XₙYₙZₙ, for example. Accordingly, for each data entry provided by the presenter or the remote third party user, a unique coordinate is designated that is stored in the memory 805. Thereby, extrapolating and expanding the original table shown in FIG. 16 to have additional columns and rows as shown in FIG. 20. The updating of the table is performed in the memory 805 by the specialized processor 804.

Still referring to FIG. 21, at step 2103, the processor 804 designates the plurality of data received by a third party based on the specific coordinates where the data is entered. At step 2104, the processor 804 also further distinguishes and segregates the data entered by a first third party and a different second third party, as shown in FIG. 20. At step 2105, the processor 804, after updating its memory with this additional information, transmits the additional information to the server. At step 2106, the server transmits this additional information back to the third party users that are connected to the server such that each third party user can see the input entered by the other third party user in the group. For example, data entry by remote user one (1) is viewable by remote user two (2), and vice-versa.

At step 2107, the processor 804 masks or filters the information received from the presenter and the additional information received from the third party users. The processor 804 recognizes the information being from the presenter versus the third party users based on where the information is being received from. For example, one way may be to have a unique identifier affixed to the data received based on whether the data received is from the presenter versus the third party users. At step 2108, the processor 804 designates each additional information from a prospective third party user with a specific source identifying marker or identifier such that the additional information received from a first third party user is represented in a different manner than the additional information received from a different second third party user. The source identifying marker or identifier may include color, a font, a pattern or shading, etc., that assists in differentiating and distinguishing the additional information received from the first third party user and the additional information received from the second third party user. At step 2109, the processor 804 corresponds each additional information with a specific third party user. At step 2110, the processor 804 transmits, via transmitter 803 shown in FIG. 8, only the information entered by the plurality of users to a projector 106 such that the additional information is projected back onto the flat surface 101. That is, the processor 804 does not project the information received from the presenter onto the flat surface 101. Only the additional information received from the remote third party users is projected onto the flat surface 101. On step 2111, the projector 106 projects the additional information from the third party user in the specific color designated by the processor 804 and annotates the projection with the third party user that provided the additional information.

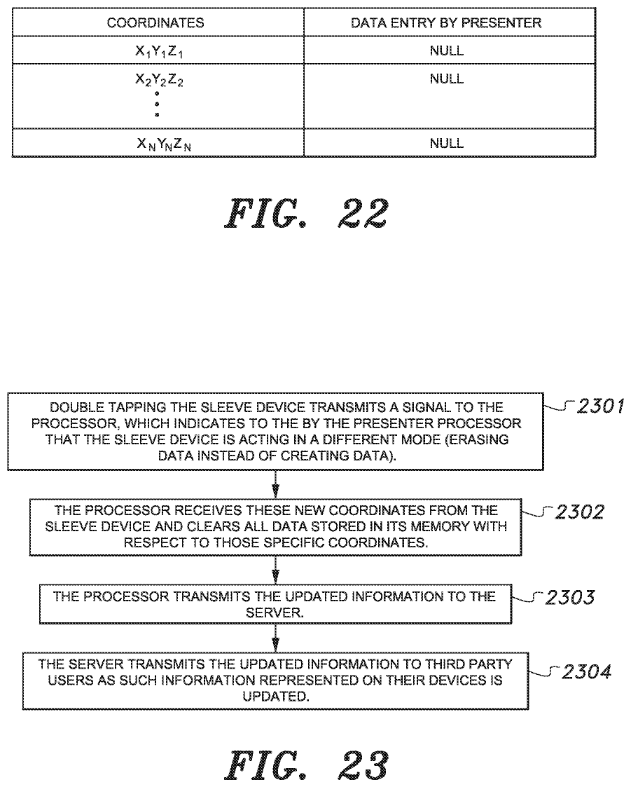

Next, referring to FIGS. 22-23 a specialized algorithm directed to erasing or removing of information provided by the presenter will be discussed. At step 2301, as shown in FIG. 23, the presenter can erase a specific region on the flat surface 101 by double tapping the actuator 102-2 on the sleeve device 102 and maneuvering the sleeve device 102 around the region that needs to be erased. The double tapping of the sleeve device 102 transmits a signal to the processor 804, which indicates to the processor 804 that the sleeve device 102 is acting in a different mode (i.e., erasing data instead of creating data). As such, any plurality of coordinates transmitted after the double tapping are associated with a “Null” value as shown in FIG. 22. “Null” value corresponds to no data being associated with that particular coordinate. At step 2302, the processor 804 receives these new coordinates from the sleeve device 102 and clears all data stored in its memory 805 with respect to those specific coordinates. At step 2303, the processor 804 transmits, via the transmitter 803 shown in FIG. 8, the updated information to the server. And, lastly, at step 2304 the server transmits the updated information to the plurality of third devices 108-1, 108-2, 108-3 such that the remote third party users are viewing the updated information on their devices.

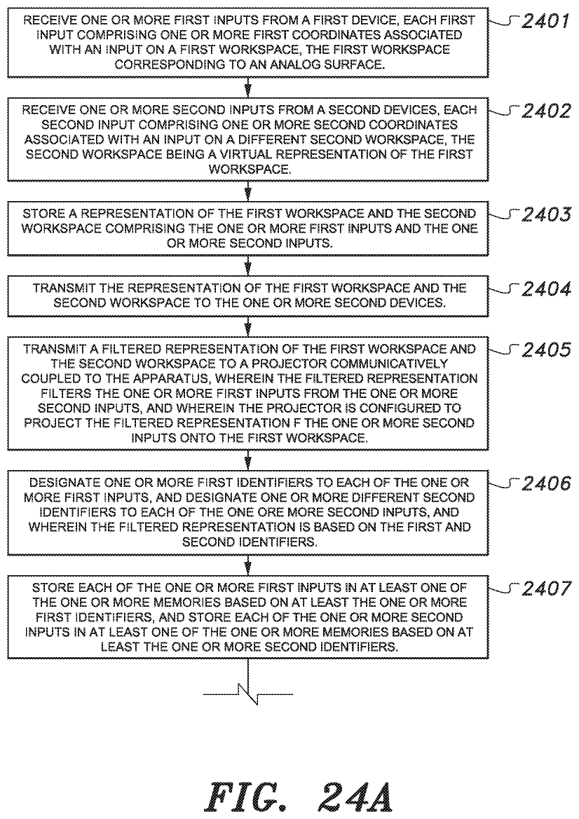

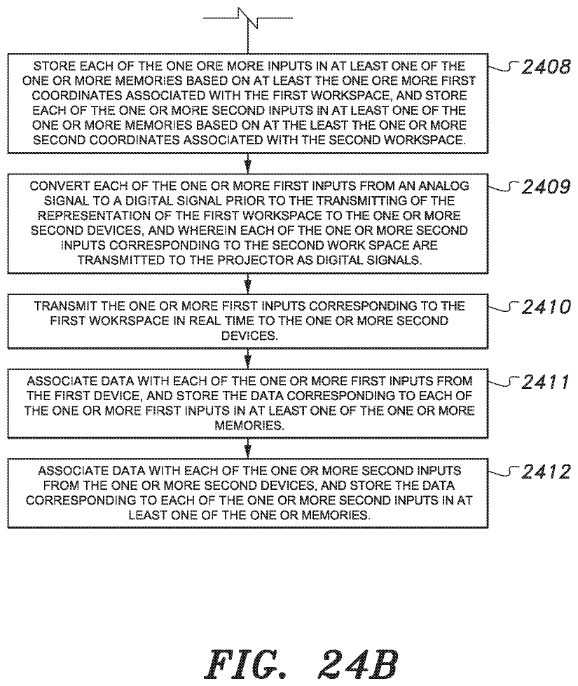

Next, referring to FIGS. 24A-B a specialized algorithm for synchronizing data in real time across analog and digital workspaces according to an exemplary embodiment is illustrated. The specialized algorithm disclosed herein may be configured to be executed by a computing device or specialized computer 107, shown in FIGS. 1, 2 and 7, or a server (not shown). As discussed above, the server, like the specialized computer 107, includes a specialized processor that is configured to execute the specialized algorithm set forth in FIGS. 24A-B upon execution of specialized computer code or software. The specialized computer code or software being stored in one or more memories similar to memory 805 shown in FIG. 8, wherein the storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium of the server may include volatile, nonvolatile, dynamic, static, read/write, read-only, random-access, sequential-access, location-addressable, file-addressable, and/or content-addressable devices. The one or more memories being operatively coupled to at least one of the one or more processors and having instructions stored thereon.

The specialized processor in the server or the computing device may be configured to, at step 2401, receive one or more first inputs from a first device, each first input comprising one or more first coordinates associated with an input on a first workspace, the first workspace corresponding to an analog surface. As noted above, the specialized algorithm set forth above may be executed by a processor in a server or by the computing device. When executed by the server, the server is operatively coupled to the first device and the one or more second devices 108-1, 108-2, 108-3, and wherein the first device is a computing device coupled to the projector 106. Wherein, the one or more first inputs received from the first device corresponds to the one or more first coordinates generated by a sleeve device 102 upon actuation of the sleeve device 102 on the first workspace (i.e., flat surface 101). Alternatively, if executed by the computing device 107, the computing device 107 is operatively coupled to the first device and the one or more second devices 108-1, 108-2, 108-3, and wherein the first device is a sleeve device 102. The one or more first inputs correspond to the one or more first coordinates generated by the sleeve device 102 upon actuation of the sleeve device 102 on the first workspace (i.e., flat surface 101).

At step 2402, the processor 804 may further receive one or more second inputs from one or more second devices, each second input comprising one or more second coordinates associated with an input on a different second workspace, the second workspace being a virtual representation of the first workspace. When executed by a computing device 107, or alternatively the server, coupled to the projector 106, the second device can be plurality of devices 108-1, 108-2, 108-3 operated by the remote third party users, as shown in FIG. 6, that detects the second input coordinates entered by the remote third party users via their respective plurality of devices 108-1, 108-2, 108-3. The second workspace can be the virtual representation of the flat surface 101 on the respective plurality of devices 108-1, 108-2, 108-3.

At step 2403, the processor 804 may further store a representation of the first workspace and the second workspace comprising the one or more first inputs and the one or more second inputs. When executed by a computing device 107, or alternatively the server, representation of the first workspace, which can be that of the flat surface 101, and representation of the second workspace, which can be that of the virtual representation of the flat surface 101 on the plurality of devices 108-1, 108-2, 108-3, can be stored in a memory 805 as shown in FIG. 8.

At step 2404, the processor 804 may further transmit the representation of the first workspace and the second workspace to the one or more second devices. When executed by a computing device 107, or alternatively the server, the representation of the flat surface 101 and the virtual representation of the flat surface on a respective one of the plurality of devices 108-1, 108-2, 108-3 can be transmitted to a different one of the plurality of devices 108-1, 108-2, 108-3. Thereby, promoting content sharing between different third party remote users. And, at step 2405 transmit a filtered representation of the first workspace and the second workspace to a projector 106 communicatively coupled to the apparatus, wherein the filtered representation filters the one or more first inputs from the one or more second inputs, and wherein the projector 106 is configured to project the filtered representation of the one or more second inputs onto the first workspace. When executed by a computing device 107, or alternative the server, the first workspace 101 is filtered from the second workspace and the second workspace is transmitted by signal 109-4 to the projector 106 as shown in FIG. 7. The projector 106 thereafter projects the second workspace to the flat surface 101 as represented by signal 109-5 shown in FIG. 7.

Still referring to FIGS. 24A-B, at step 2406 the processor 804 may be further configured to execute the computer readable instructions stored in at least one of the one or more memories to designate one or more first identifiers to each of the one or more first inputs, and designate one or more different second identifiers to each of the one or more second inputs, and wherein the filtered representation is based on the first and second identifiers. The first and second identifiers correspond to source identifying marker as discussed above under step 2108 in FIG. 21. And, the first inputs and second inputs correspond to inputs from the presenter and remote third party users as discussed above. When executed by a computing device 107, or alternative the server, the first inputs provided by the sleeve device 102, as shown in FIG. 16, will be designated a first identifier as shown in step 2108 of FIG. 21; and the second inputs provided by the remote third party users, as shown in FIG. 20, will be designated a different second identifier as shown in step 2108 of FIG. 21.

At step 2407, the processor is further configured to execute the computer readable instructions stored in at least one of the one or more memories to store each of the one or more first inputs in at least one of the one or more memories based on at least the one or more first identifiers, and store each of the one or more second inputs in at least one of the one or more memories based on at least the one or more second identifiers. When executed by a computing device 107, or alternative the server, the first and second inputs, as discussed above, will be stored along with their unique identifiers in memory 805 as shown in FIGS. 8 and 18.

Next, at step 2408, the processor is further configured to execute the computer readable instructions stored in at least one of the one or more memories to store each of the one or more first inputs in at least one of the one or more memories based on at least the one or more first coordinates associated with the first workspace, and store each of the one or more second inputs in at least one of the one or more memories based on at least the one or more second coordinates associated with the second workspace. When executed by a computing device 107, or alternative the server, the first and second inputs, as discussed above, will be stored along with their unique identifiers in memory 805 as shown in FIGS. 8 and 20.

At step 2409, the processor is further configured to execute the computer readable instructions stored in at least one of the one or more memories to convert each of the one or more first inputs from an analog signal to a digital signal prior to the transmitting of the representation of the first workspace to the one or more second devices, and wherein each of the one or more second inputs corresponding to the second work space are transmitted to the projector as digital signals. When executed by a computing device 107, or alternative the server, the first input or signal 109-1, shown in FIGS. 6-7, is converted from analog signal to digital signal 109-2, and the second input or signal 109-3 are transmitted to the projector 106 as digital signals 109-4, also shown in FIGS. 6-7.

One skilled in the art would appreciate that analog signals are continuous signals that contain time-varying quantities. For example, analog signals may be generated and incorporated in various types of sensors such as light sensors (to detect the amount of light striking the sensors), sound sensors (to sense the sound level), pressure sensors (to measure the amount of pressure being applied), and temperature sensors (such as thermistors). In contrast, digital signals include discrete values at each sampling point that retain a uniform structure, providing a constant and consistent signal, such as unit step signals and unit impulse signals. For example, digital signals may be generated and incorporated in various types of sensors such as digital accelerometers, digital temperature sensors,

At step 2410, the processor is further configured to execute the computer readable instructions stored in at least one of the one or more memories to transmit the one or more first inputs corresponding to the first workspace in real time to the one or more second devices. When executed by a computing device 107, or alternatively the server, the signals 109-1 or first input are transmitted to the plurality of devices 108-1, 108-2, 108-3 in real time as shown in FIGS. 6-7.

Still referring to FIGS. 24A-B, at step 2411, the processor is further configured to execute the computer readable instructions stored in at least one of the one or more memories to associate data with each of the one or more first inputs from the first device, and store the data corresponding to each of the one or more first inputs in at least one of the one or more memories. When executed by a computing device 107, or alternatively the server, the first inputs are associated as data from the sleeve device 102, as shown in FIGS. 16 and 20, which are stored in memory 805. And, lastly, at step 2412, the processor is further configured to execute the computer readable instructions stored in at least one of the one or more memories to associate data with each of the one or more second inputs from the one or more second devices, and store the data corresponding to each of the one or more second inputs in at least one of the one or memories. When executed by a computing device 107, or alternatively the server, the second inputs are associated from the plurality of remote devices 108-1, 108-2, 108-3, as shown in FIG. 20, which are stored in memory 805.

Each computer program can be stored on an article of manufacture, such as a storage medium (e.g., CD-ROM, hard disk, or magnetic diskette) or device (e.g., computer peripheral), that is readable by a programmable computer for configuring and operating the computer when the storage medium or device is read by the computer to perform the functions of the data framer interface.

As used herein, computer program and/or software can include any sequence or human or machine cognizable steps which perform a function. Such computer program and/or software can be rendered in any programming language or environment including, for example, C/C++, C#, Fortran, COBOL, MATLAB™, PASCAL, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., BREW), and the like.

It will be recognized that while certain aspects of the disclosure are described in terms of a specific sequence of steps of a method, these descriptions are only illustrative of the broader methods of the disclosure, and can be modified as required by the particular application. Certain steps can be rendered unnecessary or optional under certain circumstances. Additionally, certain steps or functionality can be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated can be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments can be understood and effected by those skilled in the art in practicing the claimed disclosure, from a study of the drawings, the disclosure and the appended claims.

Methods disclosed herein can be implemented in one or more processing devices (e.g., a digital processor, an analog processor, a digital circuit designed to process information, an analog circuit designed to process information, a state machine, and/or other mechanism for electronically processing information and/or configured to execute computer program modules stored as computer readable instructions). The one or more processing devices can include one or more devices executing some or all of the operations of methods in response to instructions stored electronically on a non-transitory electronic storage medium. The one or more processing devices can include one or more devices configured through hardware, firmware, and/or software to be specifically designed for execution of one or more of the operations of methods herein.

Further, while the server is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present inventive concepts can be realized in a variety of apparatus including electronic devices implemented using any combination of circuitry and software.

The processor(s) and/or controller(s) implemented and disclosed herein can comprise both specialized computer-implemented instructions executed by a controller and hardcoded logic such that the processing is done faster and more efficiently. This in turn, results in faster decision making by processor and/or controller, thereby achieving the desired result more efficiently and quickly. Such processor(s) and/or controller(s) are directed to special purpose computers that through execution of specialized algorithms improve computer functionality, solve problems that are necessarily rooted in computer technology and provide improvements over the existing prior art(s) and/or conventional technology.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, un-recited elements or method steps; the term “having” should be interpreted as “having at least;” the term “such as” should be interpreted as “such as, without limitation;” the term “includes” should be interpreted as “includes but is not limited to;” the term “example” is used to provide exemplary instances of the item in discussion, not an exhaustive or limiting list thereof, and should be interpreted as “example, but without limitation;” adjectives such as “known,” “normal,” “standard,” and terms of similar meaning should not be construed as limiting the item described to a given time period or to an item available as of a given time, but instead should be read to encompass known, normal, or standard technologies that can be available or known now or at any time in the future.

Further, use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that can or cannot be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise.

The terms “about” or “approximate” and the like are synonymous and are used to indicate that the value modified by the term has an understood range associated with it, where the range can be ±20%, +15%, +10%, +5%, or +1%. The term “substantially” is used to indicate that a result (e.g., measurement value) is close to a targeted value, where close can mean, for example, the result is within 80% of the value, within 90% of the value, within 95% of the value, or within 99% of the value. Also, as used herein “defined” or “determined” can include “predefined” or “predetermined” and/or otherwise determined values, conditions, thresholds, measurements, and the like.

What is claimed is:

1. An apparatus for synchronizing data in real time across analog and digital workspaces, the apparatus comprising:
one or more processors; and
one or more memories operatively coupled to at least one of the one or more processors and having instructions stored thereon that, when executed by at least one of the one or more processors, cause at least one of the one or more processors to:
receive one or more first inputs from a first device, each first input comprising one or more first coordinates associated with an input on a first workspace, the first workspace corresponding to an analog surface;
receive one or more second inputs from one or more second devices, each second input comprising one or more second coordinates associated with an input on a different second workspace, the second workspace being a virtual representation of the first workspace;
store a representation of the first workspace and the second workspace comprising the one or more first inputs and the one or more second inputs;
transmit the representation of the first workspace and the second workspace to the one or more second devices; and
transmit a filtered representation of the first workspace and the second workspace to a projector communicatively coupled to the apparatus, wherein the filtered representation filters the one or more first inputs from the one or more second inputs, and wherein the projector is configured to project the filtered representation of the one or more second inputs onto the first work space.

2. The apparatus of claim 1, wherein the one or more processors is included in a server operatively coupled to the first device and the one or more second devices, and wherein the first device is a computing device coupled to the projector.

3. The apparatus of claim 1, wherein the one or more processors is included in a computing device operatively coupled to the first device and the one or more second devices, and wherein the first device is a sleeve device.

4. The apparatus of claim 2, wherein the one or more first inputs received from the first device corresponds to the one or more first coordinates generated by a sleeve device upon actuation of the sleeve device on the first workspace.

5. The apparatus of claim 3, wherein the one or more first inputs correspond to the one or more first coordinates generated by the sleeve device upon actuation of the sleeve device on the first workspace.

6. The apparatus of claim 1,
wherein at least one of the one or more memories has further instructions stored thereon that, when executed by at least one of the one or more processors, cause at least one of the one or more processors to:
designate one or more first identifiers to each of the one or more first inputs, and
designate one or more different second identifiers to each of the one or more second inputs, and
wherein the filtered representation is based on the first and second identifiers.

7. The apparatus of claim 6, wherein at least one of the one or more memories has further instructions stored thereon that, when executed by at least one of the one or more processors, cause at least one of the one or more processors to:
store each of the one or more first inputs in at least one of the one or more memories based on at least the one or more first identifiers, and
store each of the one or more second inputs in at least one of the one or more memories based on at least the one or more second identifiers.

8. The apparatus of claim 1, wherein at least one of the one or more memories has further instructions stored thereon that, when executed by at least one of the one or more processors, cause at least one of the one or more processors to:
store each of the one or more first inputs in at least one of the one or more memories based on at least the one or more first coordinates associated with the first work space, and
store each of the one or more second inputs in at least one of the one or more memories based on at least the one or more second coordinates associated with the second work space.

9. The apparatus of claim 1, wherein at least one of the one or more memories has further instructions stored thereon that, when executed by at least one of the one or more processors, cause at least one of the one or more processors to:
convert each of the one or more first inputs from an analog signal to a digital signal prior to the transmitting of the representation of the first workspace to the one or more second devices, and wherein each of the one or more second inputs corresponding to the second work space are transmitted to the projector as digital signals.

10. The apparatus of claim 1, wherein at least one of the one or more memories has further instructions stored thereon that, when executed by at least one of the one or more processors, cause at least one of the one or more processors to:
transmit the one or more first inputs corresponding to the first workspace in real time to the one or more second devices.

11. The apparatus of claim 1, wherein at least one of the one or more memories has further instructions stored thereon that, when executed by at least one of the one or more processors, cause at least one of the one or more processors to:
associate data with each of the one or more first inputs from the first device, and
store the data corresponding to each of the one or more first inputs in at least one of the one or more memories.

12. The apparatus of claim 1, wherein at least one of the one or more memories has further instructions stored thereon that, when executed by at least one of the one or more processors, cause at least one of the one or more processors to:
associate data with each of the one or more second inputs from the one or more second devices, and
store the data corresponding to each of the one or more second inputs in at least one of the one or memories.

13. A method for synchronizing data in real time across analog and digital workspaces, comprising:
receiving one or more first inputs from a first device, each first input comprising one or more first coordinates associated with an input on a first workspace, the first workspace corresponding to an analog surface;
receiving one or more second inputs from one or more second devices, each second input comprising one or more second coordinates associated with an input on a different second workspace, the second workspace being a virtual representation of the first workspace;
storing a representation of the first workspace and the second workspace comprising the one or more first inputs and the one or more second inputs;
transmitting the representation of the first workspace and the second workspace to the one or more second devices; and
transmitting a filtered representation of the first workspace and the second workspace to a projector communicatively coupled to the apparatus, wherein the filtered representation filters the one or more first inputs from the one or more second inputs, and wherein the projector is configured to project the filtered representation of the one or more second inputs onto the first work space.

14. The method of claim 13, further comprising:
designating one or more first identifiers to each of the one or more first inputs, and
designating one or more different second identifiers to each of the one or more second inputs, and
wherein the filtered representation is based on the first and second identifiers.

15. The method of claim 14, further comprising:
storing each of the one or more first inputs in at least one of one or more memories based on at least the one or more first identifiers, and
storing each of the one or more second inputs in at least one of the one or more memories based on at least the one or more second identifiers.

16. The method of claim 13, further comprising:
storing each of the one or more first inputs in at least one of one or more memories based on at least the one or more first coordinates associated with the first work space, and
store each of the one or more second inputs in at least one of the one or more memories based on at least the one or more second coordinates associated with the second work space.

17. The method of claim 13, further comprising:
converting each of the one or more first inputs from an analog signal to a digital signal prior to the transmitting of the representation of the first workspace to the one or more second devices, and wherein each of the one or more second inputs corresponding to the second work space are transmitted to the projector as digital signals.

18. The method of claim 13, further comprising:
transmitting the one or more first inputs corresponding to the first workspace in real time to the one or more second devices.

19. The method of claim 13, further comprising:
associating data with each of the one or more first inputs from the first device, and
storing the data corresponding to each of the one or more first inputs in at least one of the one or more memories.

20. The method of claim 13, further comprising:
associating data with each of the one or more second inputs from the one or more second devices, and
storing the data corresponding to each of the one or more second inputs in at least one of the one or memories.
